(19) United States
(12) Patent Application Publication
(10) Pub. No.: US 2026/0050442 A1
(43) Pub. Date: Feb. 19, 2026

(54) AUTOMATIC GENERATION OF CONTROL AND STATUS REGISTERS BASED ON CONFIGURATION OF COMPONENTS IN NETWORK-ON-CHIP

(71) Applicant: Baya Systems, Inc., Santa Clara, CA (US)

(72) Inventors: Honnahuggi Harinath Venkata Naga Ambica PRASAD, Bengaluru (IN); Narayana Sri Harsha GADE, Bangalore (IN); Govind JAIN, Odisha (IN); Eric NORIGE, Santa Clara, CA (US)

(21) Appl. No.: 18/773,212

(22) Filed: Jul. 15, 2024

(51) Int. Cl. G06F 9/30

(52) U.S. Cl. CPC G06F 9/30123

(57) ABSTRACT

System and methods for automatically generating control/status registers (CSR) based on configurations of components in a Network on Chip (NoC) include generating at least one repeatable field group from a plurality of defined fields, each of the plurality of defined fields defining portions of a register and NoC connectivity, generating at least one repeatable multi-register from the at least one repeatable field group, and generating at least one CSR group from the at least one repeatable multi-register, the at least one CSR group generated to be incorporated into a CSR bank. Such systems and methods of generating CSRs provides flexibility for designers/users to optimize the NoC for area consumption, reducing cost and complexity, parameterize configurations of the CSRs, and the like.

### BACKGROUND

### Technical Field

Methods and example embodiments described herein are generally directed to designing registers for components of Network on Chips (NoCs), and more specifically, to automatic generation of control and status registers (CSR) based on component configurations of the NoC.

### Related Art

The number of components on a chip is rapidly growing due to increasing levels of integration, system complexity, and shrinking transistor geometry. Complex System-on-Chips (SoCs) may involve a variety of components, e.g., processor cores, digital signal processors (DSPs), hardware accelerators, memory, and Input/Output (I/O) subsystems, while Chip Multi-Processors (CMPs) may involve a large number of homogenous processor cores, memory, and I/O subsystems. In both systems, the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

NoC is a global shared communication infrastructure made up of several routing nodes interconnected with each other using point-to-point physical links. Messages are injected by the source and are routed from the source node/router to the destination node/router over multiple intermediate nodes and physical links. The destination node/router then ejects the message and provides it to the destination. For the remainder of the document, terms ‘processing elements,’ ‘components,’ ‘blocks,’ ‘hosts,’ or ‘cores,’ will be used interchangeably to refer to the various system components which are interconnected using a NoC. Further, terms ‘routers’and ‘nodes’may also be used interchangeably. Without loss of generalization, the system with multiple interconnected components will itself be referred to as a ‘multi-core system.’

There are several possible topologies in which the routers can connect to one another to create the system network. Bi-directional rings 100A (as shown in FIGS. 1A) and 2-D mesh 100B (as shown in FIG. 1B) are examples of topologies in the related art.

Packets are message transport units for intercommunication between various components. Routing involves identifying a path which is a set of routers and physical links of the network over which packets are sent from a source to a destination. Components are connected to one or multiple ports of one or multiple routers, with each such port having a unique identifier (ID). Packets carry the destination's router and port ID for use by the intermediate routers to route the packet to the destination component.

Examples of routing techniques include deterministic routing, which involves choosing the same path from A to B for every packet. This form of routing is oblivious to the state of the network and does not load balance across path diversities which may exist in the underlying network. However, such deterministic routing may be simple to implement in hardware, maintains packet ordering, and may be easy to make free of network-level deadlocks. Shortest path routing minimizes the latency as it reduces the number of hops from the source to the destination. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. More specifically, FIG. 2 illustrates XY routing from node ‘34’ to node ‘00.’ In the example of FIG. 2, each component is connected to only one port of one router. A packet is first routed in the X dimension till the packet reaches node ‘04,’ where the x dimension is same as the destination. The packet is next routed in the Y dimension until the packet reaches the destination node.

Source routing and routing using tables are other routing options used in NoC. Adaptive routing can dynamically change the path taken between two points in the network based on the state of the network. This form of routing may be complex to analyze and implement and is therefore rarely used in practice.

A NoC may contain multiple physical networks. Over each physical network, there may exist multiple virtual networks, where different message types are transmitted over different virtual networks. In this case, at each physical link or channel, there are multiple virtual channels, where each virtual channel may have dedicated buffers at both end points. In any given clock cycle, only one virtual channel can transmit data on the physical channel.

NoC interconnects often employ wormhole routing, where a large message or packet is broken into small pieces known as flits (also referred to as flow control digits). The first flit is the header flit which holds information about the packet's route and key message level information along with payload data and sets up the routing behavior for all subsequent flits associated with the message. Zero or more body flits follow the head flit, containing the remaining payload of data. The final flit is a tail flit which in addition to containing the last payload also performs some bookkeeping to close the connection for the message. In wormhole flow control, virtual channels are often implemented.

The physical channels are time-sliced into a number of independent logical channels called virtual channels (VCs). VCs provide multiple independent paths to route packets; however, they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” refers to the way messages are transmitted over the channels; the output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

Routers or nodes in the NoC are associated with Control/Status Registers (CSRs). Each of such registers are addressable units of CSR configuration, usually 32 or 64 bits, that are atomically modifiable. The registers include fields that have a single function/purpose. For example, an address map configuration register may have a single-bit field that controls whether the address map entry corresponding to that register is enabled (participates in address decode). That register may also have another field controlling which addresses matches this address range.

Registers have defined access types that specify how the register interacts with CSR controllers and NoC components. The simplest access types are read-only and read-write, with many registers being non-modifiable by the CSR controller and others being fully reprogrammable. Additionally, information about how the component interacts with the register can also be captured. Status registers are usually “volatile,” meaning that their value can be and will be changed (by the component) without any write from the CSR controller. Some registers are “Write zero to clear,” meaning that writing a value other than 0 will not have any effect and only writing the value 0 clears the register. Other kinds of access types are known to those skilled in the art.

Registers also have multi-bit field called “bit enables” can have some of its bits “disabled” or fixed to a particular value to reduce implementation cost. The pattern of disabled bits within a field is captured by that field's bit enables.

Existing CSRs are implemented within the (NoC) components, which imposes design limitations that reduce flexibility for designers/users for determining design parameters for the registers. There exists a need for methods, systems, and computer readable mediums for overcoming the above-mentioned issues with existing implementations for generating CSRs.

### SUMMARY

Aspects of the present disclosure are directed to a method for automatic generation of control and status registers (CSRs), which includes generating at least one repeatable field group from a plurality of defined fields, each of the plurality of defined fields defining portions of a register and Network on Chip (NoC) connectivity, generating at least one repeatable multi-register from the at least one repeatable field group, and generating at least one CSR group from the at least one repeatable multi-register, the at least one CSR group generated to be incorporated into a CSR bank.

Additional aspects of the present disclosure are directed to a computer-readable storage medium storing instructions for executing a process for automatic generation of CSRs, the instructions include generating at least one repeatable field group from a plurality of defined fields, each of the plurality of defined fields defining portions of a register and NoC connectivity, generating at least one repeatable multi-register from the at least one repeatable field group, and generating at least one CSR group from the at least one repeatable multi-register, the at least one CSR group generated to be incorporated into a CSR bank.

Further aspects of the present disclosure are directed to a system having a control module configured to generate at least one repeatable field group from a plurality of defined fields, each of the plurality of defined fields defining portions of a register and NoC connectivity, generate at least one repeatable multi-register from the at least one repeatable field group, and generate at least one CSR group from the at least one repeatable multi-register, the at least one CSR group generated to be incorporated into a CSR bank.

### BRIEF DESCRIPTION OF THE DRAWINGS

FIGS. 1A and 1B illustrate examples of Bidirectional ring and 2D Mesh Network on Chip (NoC) topologies.

FIG. 2 illustrates an example of XY routing in a NoC having a two-dimensional mesh topology.

FIG. 3A illustrates a schematic representation of a NoC having components associated with control and status registers (CSRs), in accordance with an example implementation.

FIG. 3B illustrates a schematic representation of a single CSR bank shared by multiple components, in accordance with an example implementation.

FIG. 3C illustrates a schematic representation of internal details of the CSR banks, in accordance with an example implementation.

FIG. 4 illustrates a flowchart for automatic generation of CSRs based on configuration of components of the NoC, in accordance with an example implementation.

FIG. 5 illustrates a schematic representation of an example NoC having multiple clusters, in accordance with an example implementation.

FIG. 6 illustrates a computer/server block diagram upon which the example implementations described herein may be implemented.

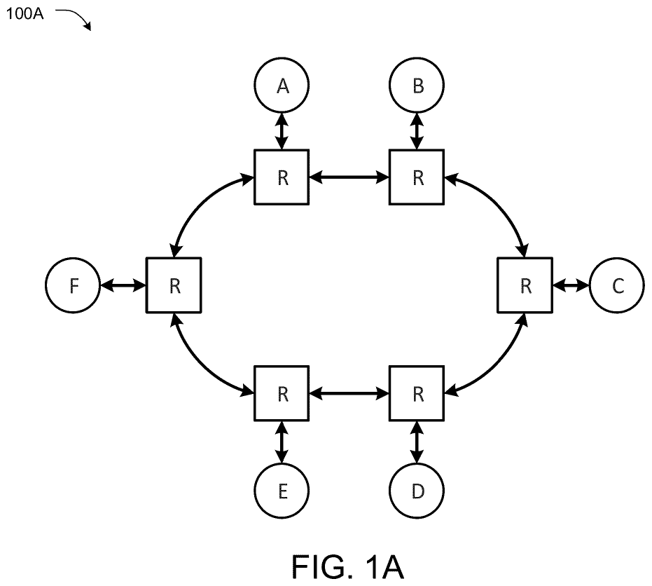

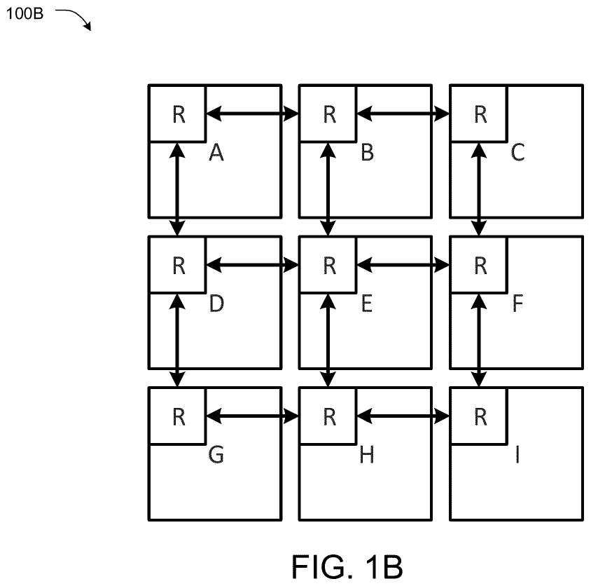

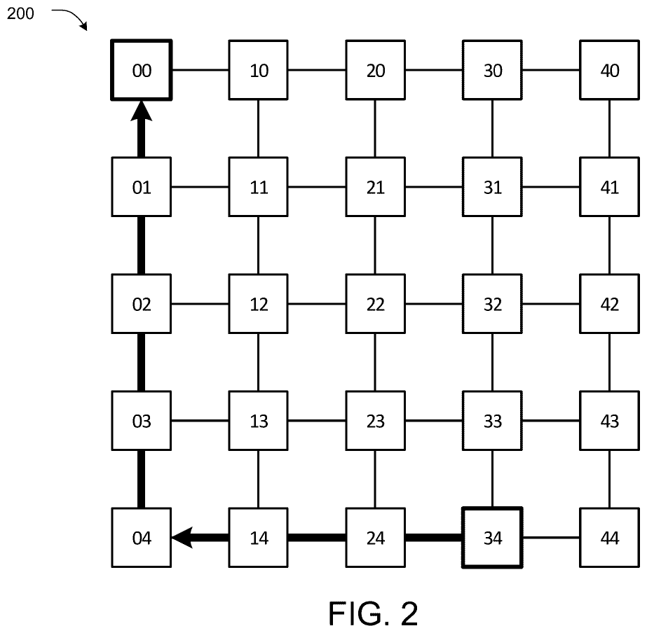

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term ‘automatic’ may involve fully automatic or semi-automatic implementations involving user or administrator control over certain aspects of the implementation, depending on the desired implementation of one of ordinary skill in the art practicing implementations of the present disclosure.

Control/status registers (CSRs) are used for storing control and/or status information or instructions associated with the operation of components/elements in a Networks on Chip (NoC) and/or System on Chips (SoCs). The CSRs (also interchangeably referred to as registers) are typically implemented within components, such as within routers, bridges, Cache Coherency Controllers (CCCs), Last Level Caches (LLCs), and the like. The CSRs may store configuration or status information that may be written and/or read by the components during operation. The CSRs of the components may also be serviced by a CSR controller (which in turn may receive requests/commands from external agents for reconfiguring the components, for example) through a set of CSR endpoints. However, in implementations where the CSRs are placed within the components, the flexibility for designers/users in choosing/configuring the number of endpoints, among other aspects, of the NoC is reduced. Existing solutions that implement the registers inside the components require the number of decoders that receive control commands/information from the CSR controllers to be equal to the number of components, which necessitates the number of CSR endpoints to also be equal to the number of components, thereby increasing costs and introducing the complexity of the CSR network.

Additionally, such implementations limit the flexibility for designers to determine or parameterize the number of registers to be implemented in a register group, or register banks, and other specifications of the registers such as number of bits, reset values, access types, number of fields, or field groups, enabling bits, offsets, and the like.

The present disclosure provides for an implementation where the registers are outside the components, which allows improved flexibility in choosing the number of endpoints required to allow CSR controllers to service the components. The present disclosure also provides for consolidation of multiple registers associated with multiple components/elements to form register banks or CSR banks, which may reduce the number of CSR endpoints required for implementing the CSR network and thereby reduce cost and complexity. The present disclosure further provides a method for automatic generation of registers based on configurations of the component/elements in the NoC. For example, the present disclosure may allow at least one of: a number of fields in each register/CSR, the number of bits in each field, the number of physical registers to be created, enabling bits, reset values, and the like, to be determined based on the configurations of the components of the NoC.

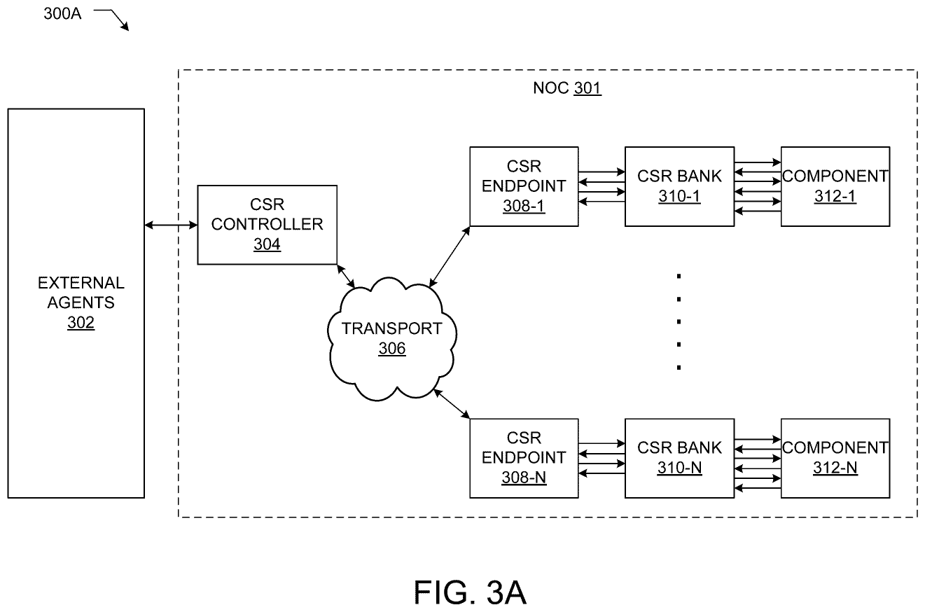

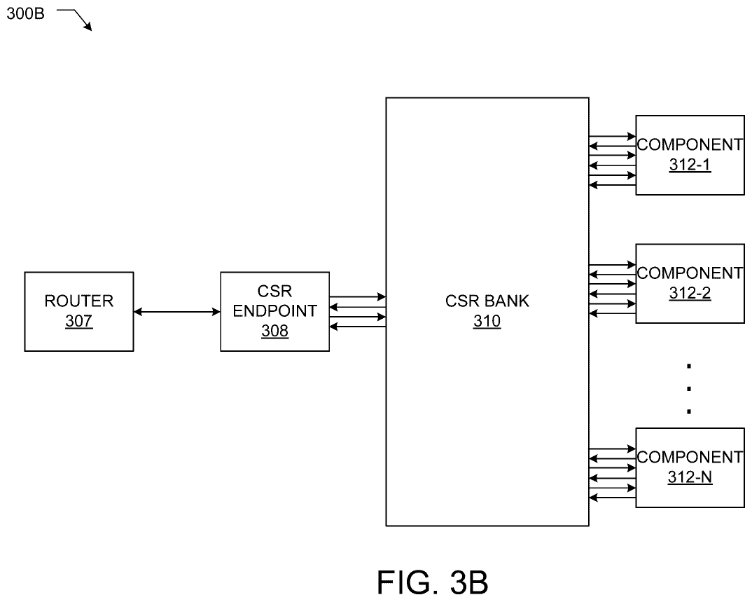

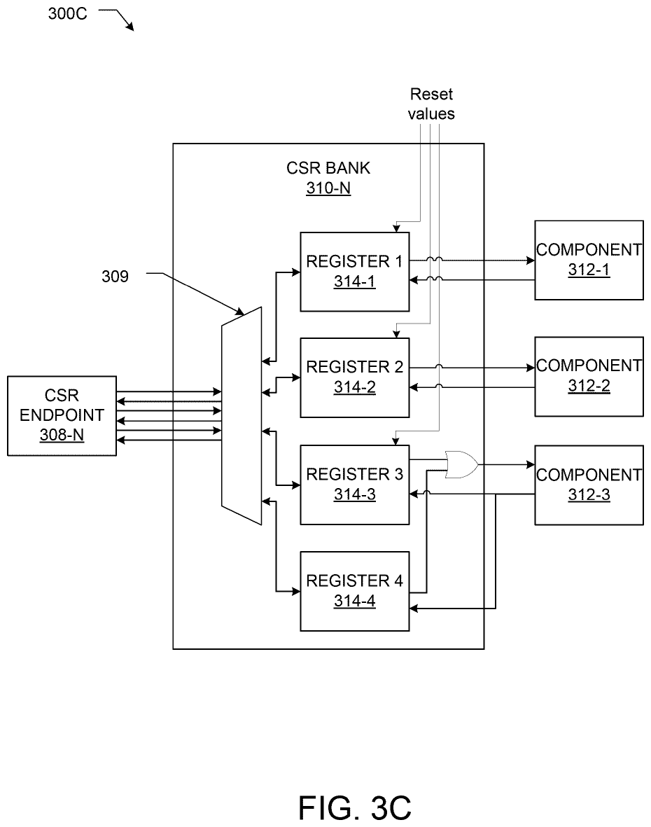

As shown in schematic representation 300A in FIG. 3A, a NoC 301 may have one or more CSR banks 310-1 to 310-N (collectively referred to as CSR banks 310) corresponding to one or more components, such as components 312-1 to 312-N (collectively referred to as components 312). Each of the CSR banks 310 may include one or more registers, such as registers 314-1 to 314-4 (collectively referred to as registers 314) shown in FIG. 3C, associated with the components 312. The components 312 may be configured to read and/or write bits/values from and to the registers 314 in the CSR banks 310. The components 312 and the CSR banks 310 may be connected through a dense set of wires to enable such read and write operations. Wires from the CSR banks 310 to the components 312 may be used for write operations and wires from the components 312 to the CSR banks 310 may be used for read operations.

The CSR bank 310 may be connected to a CSR controller 304 through a CSR endpoint (such as endpoints 308-1 to 308-N corresponding to the CSR banks 310-1 to 310-N), which in-turn may communicate with the CSR controller 304 through a transport network 306. The CSR bank 310 may be connected to the CSR endpoint 308 using an interface that requires a smaller number of wires than the wires between the CSR banks 310 and the components 312. The CSR endpoints 308 may be a set of logical circuits that allow requests from the CSR controller 304 to access and modify values held in the CSR bank 310. The CSR endpoint 308 may be configured to retrieve a value for a given address and a read/write operation from the CSR banks 310. The transport network 306 may include one or more NoC components (such as routers and bridges other than the components 312) that form the NoC, which enable data packets or signals to be transported from one component 312 to another, including the CSR controller 304 and the CSR endpoints 308. The transport network 306 may be implemented using any design pattern known to those in the art, such as a cluster design pattern or a sub-NoC design pattern where transport network 306 is connected to other transport networks using either bridges or routers at its boundary. The transport network 306 may be configured to operate independently of transport networks in other chiplets or dies connected thereto. Further, the CSR endpoint 308 may be connected to the transport network 306 using an interface that requires a smaller number of wires/links than the wires between the CSR banks 310 and the CSR endpoints 308.

The CSR controller 304 may be configured to control/service one or more of the components 312 (and the registers 314 thereof). The CSR controller 304 may be either at the same level of hierarchy as the CSR banks 310, or at a higher level where the CSR controller 304 services multiple CSR banks 310. In some embodiments, the CSR controller 304 may reconfigure the components 312 based on commands received from the external agent 302. The external agent 302 may reconfigure or access status information of the components 312 through the registers 314. For example, the external agents 302 may write to the CSRs 314 to reconfigure die-to-die routing based on number of clusters or connectivity therebetween.

While FIG. 3A shows a processing system implementing the NoC 301 having one CSR controller 304 connected to one external agent 302, it may be appreciated by those skilled in the art that the processing system (or the NoC 301) may have more than one CSR controller 304 or external agents 302 configured to service different subsets of components 312.

FIG. 3A shows an embodiment where each component 312 has a corresponding CSR bank 310. In other embodiments, the CSR banks 310 may be consolidated to service multiple components 312, as illustrated in schematic representation 300B in FIG. 3B. As shown, a single CSR bank 310 may include the registers 314 associated with multiple components 312. In such embodiments, the number of address bits required by the external agent 302 or the CSR controller 304 for accessing the registers 314 may decrease, which in turn reduces the cost/width of wires/links between the CSR controller 304 and the CSR endpoints 308 (through a router 307 of the transport network 306, for example), and between the CSR controller 304 and the external agent 302. The reduced number of address bits also reduces the complexity of routing of control and status information between the CSR controller 304 and the CSR banks 310.

Separating the CSRs/registers 314 from the components 312 may provide increased flexibility in designing the CSRs 314, while also optimizing the number of links and/or decoders required between the CSR endpoints 308 and the components 312, in comparison to existing architectures where the CSRs are implemented within the components and where the components are connected directly to the endpoints. The increased flexibility implies that the number of bits in each field, enabling bits, offset bits, reset values, number of registers, access types, and the like, may be determined based on any set of parameters. In some examples, the parameters may correspond to features and/or configuration of the NoC 301, or a processing system supported by the NoC 301.

FIG. 3C illustrates a schematic representation 300C of internal details of the CSR banks 310. As shown, the CSR banks 310 may include registers 314-1 to 314-4 (collectively referred to as registers 314), each being connected to the components 312-1 to 312-3. While FIG. 3C illustrates a CSR bank having 4 registers connected to 3 components, it may be appreciated by those skilled in the art that the CSR banks 310 may be adapted to have any number of registers 314 and components 312. The CSR banks 310 may be generated using a software, which may also generate the connectivity between the CSR endpoints 308, the CSR banks 310, the components 312, and the CSR controllers 304. The CSR banks 310 may be generated/represented with a Register Transfer Level (RTL) definition such as Verilog or SystemVerilog. In some embodiments, the CSR banks 310 may include one or more reset straps that allow the reset values to be configured. In some examples, the external agent 302 or the CSR controller 304 may provide the reset values. In other examples, the reset values may be provided by dedicated logic that derives them from a set of fuses, allowing each manufactured chip to have customized reset values. Reset values may be configured differently for each of the registers 314 in the CSR bank 310.

The CSR bank 310 may include a decoder 309 that fans out control information from the CSR endpoint 308 to each of the registers 314, to which the registers 314 may respond. Further, each of the registers 314 may also be connected to corresponding components 312, which may read and/or write bits into the registers 314. The CSR bank 310 may also include logical gates that combine fields (or values thereof) in the registers 314. In some embodiments, one or more of the registers 314 may be configured to service one of the components 312 by combining their values using logical circuits, such as the registers 314-3 and 314-4 servicing the component 312-3 through an OR gate. In some embodiments, each component 312 may issue read and/or write commands to multiple registers 314, such as the component 312-3 issuing read and/or write commands to both registers 314-3 and 314-4.

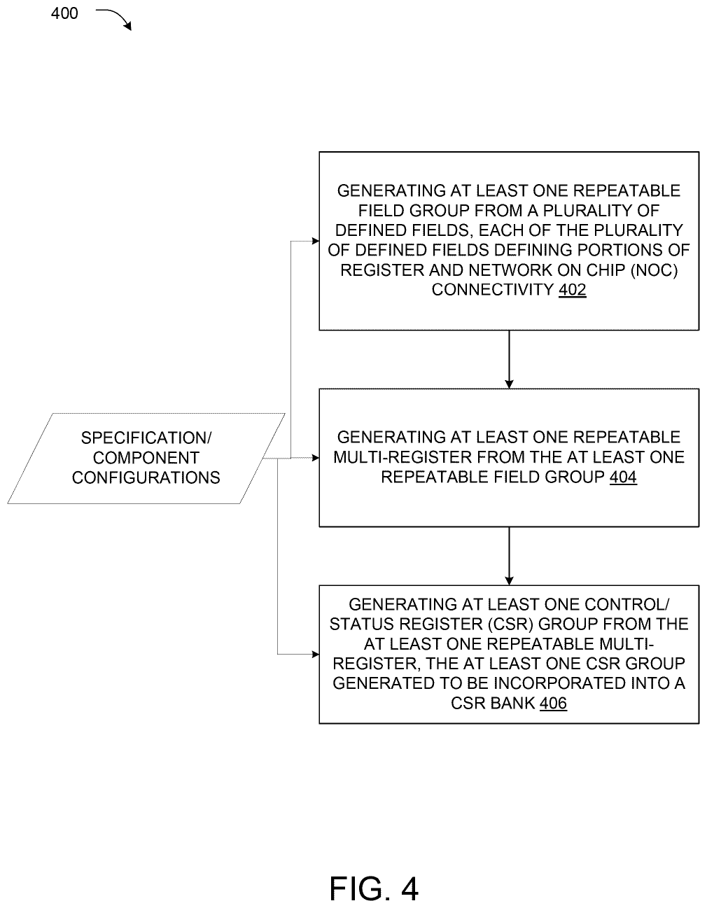

The registers 314 in the CSR bank 310 may include one or more fields that represent control/status information using one or more bits. The fields may define portions of the register. The fields may also be used to define connectivity of the NoC 301. For example, the fields may provide routing information from a source component to a destination component in the NoC 301. The fields and size of such fields may be defined by processing component configurations from a specification, using method 400 of FIG. 4 described subsequently in the present disclosure. The configurations provided in the specifications may either be associated with the component 312 corresponding to the register 314, or of the NoC 301 or processing systems supported by the NoC 301 in which the CSR banks 310 are implemented. For example, the reset values may be predetermined to a static value, or may be defined as a function of the configuration of the component 312 that the register 314 is associated with. Similarly, the size of the fields may either be static (or predetermined), or of variable size parameterized by configuration of the component 312 or the NoC 301 (such as the number of clusters in the NoC/processing system). Further, the bit enables of the register 314 and the access types of the registers 314 may also be either static or variable based on a set of parameters based on the configuration. The fields may also be modifiable/reconfigurable by the components 312 or external agents 302 using read or write commands.

FIG. 4 illustrates an example flowchart of a method 400 for automatic generation of the registers 314 based on configurations of the NoC 301. At step 402, the method 400 includes generating at least one repeatable field group from the predefined fields. The field groups may include one or more of the fields associated with at least one of the configurations of the components 312. For example, a first set of bits (such as 2 bits) may correspond to a first function, and a second set of bits (such as 3 bits) may correspond to a second function. The field groups may also be generated statically (i.e. based on predefined values as determined by the designer), or through parameterization of the features and the configuration of the NoC 301 or the components 312. Further, the fields or the field groups may be repeated multiple times based on the configurations/specifications. For example, when the NoC 301 includes multiple instantiations of a predetermined cluster design, the field groups may be repeated for each instantiation of the cluster in the register 314.

At step 404, the method 400 includes generating at least one repeatable multi-register (or register groups) from the repeatable field group. The multi-registers/register groups may refer to one or more physical registers that correspond to at least one of the configurations provided in the specification. For example, the number of bits in a physical register (corresponding to the register 314) may be insufficient to support the number of bits required to represent multiple paths/routes associated with multiple clusters in the NoC/system (i.e. configurations). In such examples, multiple physical registers may be used to support the bits required to represent the information/configuration. The bits of the multi-registers may also be aligned with the components 312, using software generated wiring between the multi-registers and the components 312. Aligning the bits may allow them to be addressable by components 312 or other elements outside the CSR bank 310. The number of physical registers required may depend on size of each physical register, and the size and number of the repeatable fields groups to be combined to form the multi-registers. In some embodiments, the multi-registers may be repeated either a fixed number of times or a variable number of times, i.e. based on the configuration provided in the specification.

In some embodiments, once the registers are generated, the registers 314 associated with each instance of the component 312 may be controlled by a corresponding CSR controller 304. The CSR controller 304 may be configured to uniquely identify each instance of the registers 314 associated with each of the components 312, and determine unique addresses/address bits (and address regions and address widths, among others) for the registers 314. Each of the registers 314 may be assigned a unique identifier (ID). The addresses may be provided in a standard format (such as those compliant with IP-XACT), which may ensure there are no overlaps between the addresses of the registers 314. In some embodiments, addresses may be determined using techniques that minimize the complexity of address decoders in the CSR controllers 304. For instance, the address bits may be optimized to maximize the utilization of address bits for a given/selected address width.

At step 406, the method 400 includes generating at least one CSR group from the repeatable multi-registers. The CSR group generated may be incorporated into a CSR bank 310. In some embodiments, the multi-registers/register group associated with each component 312 may be incorporated into a corresponding CSR bank 310, as shown in FIG. 3A. In other embodiments, the multi-registers/register groups associated with multiple components 312 may be incorporated into one CSR bank 310, as shown in FIG. 3B. For example, if a component 312 is indicative of a router connected to multiple other components 312 indicative of bridges, and all bridges and the router have registers 314 associated therewith, then such registers 314 may be grouped/consolidated into the CSR bank 310. In such examples, the CSR bank 310 may be placed next to or within the router. Consolidation may also reduce the number of bits required to address the registers 314. For instance, when different CSR banks 310 are maintained for each component 312, separate address bits may be required for identifying each of the CSR banks 310 and each of the registers 314 therein. However, if the registers 314 are consolidated into a single CSR bank 310, address bits are only needed to uniquely identify the registers 314, which may have smaller widths in comparison when the registers 314 are not consolidated.

Further, since the multi-registers may be grouped into the CSR banks 310, each CSR bank 310 may be connected to one (or a reduced number of) CSR endpoint 308, which may facilitate communication with the CSR controllers 304. Consolidating the registers 314 into the CSR banks 310 may optimize area utilization within the chip in which the NoC 301 is implemented. However, consolidating the registers 314 into CSR banks 310 may require additional wires/links between the component 312 hosting the CSR bank 310, and other components 312 whose registers 314 have been consolidated into the CSR bank 310, which may cause wiring congestion. Hence, the registers 314 may be consolidated into the CSR bank 310 based on a trade-off between optimal area utilization and addressing efficiency, among others, on one hand, and the cost and latency of wires between the CSR banks 310 and the components 312. The consolidation of the registers 314 into CSR banks 310 may also be user controllable. For example, the users/designers of the NoC/processing system may indicate which groups of components 312 will share a consolidated CSR bank 310.

Each of the generating steps 402-406 may be performed from processing component configurations from the specification. Hence, the fields, the field groups, the register groups/multi-registers, and the CSR groups/CSR banks 310 may be configured based on the configurations provided in the specification. The generated CSR banks 310 may be provided in an IP-XACT specification to allow users to configure the registers 314 therein, based on requirements. The IP-XACT may include details such as a mapping between the registers 314 and features they correspond to, their addresses, configuration details, and the like.

### EXAMPLE SCENARIO

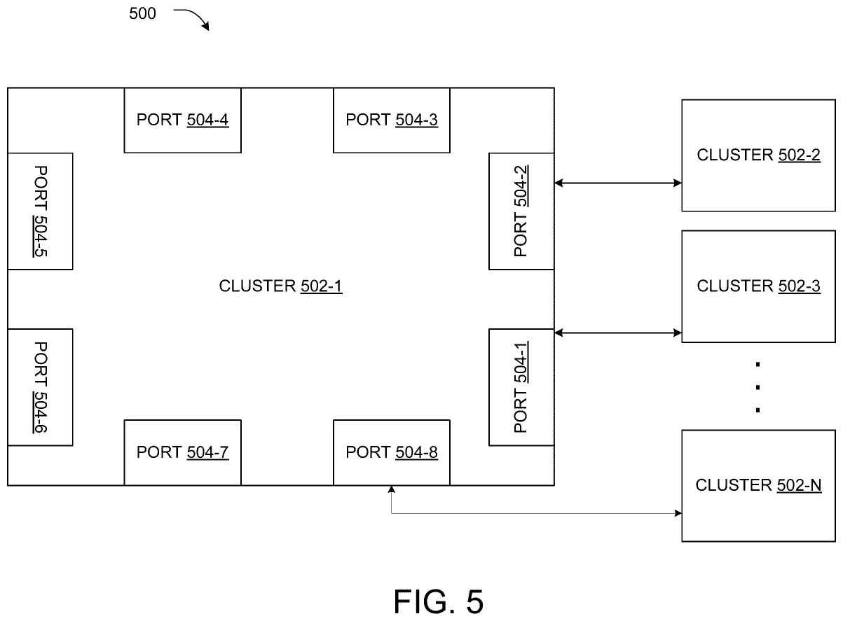

As shown in FIG. 5, a NoC 500 may have multiple clusters (such as clusters 502-1 to 502-N, which are collectively referred to as clusters 502). The clusters 502 may include boundary ports, such as boundary ports 504-1 to 504-8 (collectively referred to as boundary ports 504), which may allow the multiple clusters 502 of the NoC 500 to communicate with each other. While boundary ports 504 of only one cluster 502-1 are shown in FIG. 5, it may be appreciated the boundary ports of other clusters 502 are hidden for the purposes of clarity. Further, while 8 boundary ports are shown, each of the clusters 502 may have any and different number of boundary ports 504. The clusters 502 may be organized in a hierarchy. The clusters 502 may also include endpoints that may allow each of the clusters 502 to communicate with external agents, such as the external agent 302.

The components 312 of the clusters 502 may include CSRs/registers 314 associated therewith, which may include routing information for transmitting data packets from a source component in the clusters 502 to a destination component in any other cluster 502 associated with the NoC 500. In some implementations, the registers 314 may specify the boundary port 504 to be selected based on the destination of the packets. The component 312 (such as a bridge) associated with the register 314 may direct the packets towards the selected boundary port 504 of the clusters 502, from which the packet may be ejected.

In such implementations, the register 314 may have at least one field for each cluster 502 in the NoC 500. The total number of fields in the register 314 may depend on the number of clusters 502 in the NoC 500. In other words, the fields may be parameterized by “the number of clusters” provided in the specification. If the other clusters are instantiations of a predefined design, the fields may be repeated corresponding to the number of instantiations. Further, the number of bits in each field may be equal to the number of unique paths/routes available/configured from the source component to the destination component (or cluster thereof). Each bit in the fields may correspond to a unique path/route from one cluster to another, thereby allowing the number of bits in each field to also be parameterized. Further, at least one register 314/multi-register may be required for each boundary port 504 in the clusters 502. The multiple ones of the registers 314/multi-registers associated with one of the components 312 (such as the bridge) may be grouped into a corresponding CSR banks 310.

For example, when the NoC 500 includes 4 clusters 502, each having 8 boundaries, and where 4 paths/routes are available between each source component and each destination component, the CSR bank 310 may include 8 registers 314 with 4 fields each, and where each field has 4 bits to represent distinct routes available to each cluster 502 in the NoC 500, thereby requiring a total of 128 bits. If each physical register has 64 bits, the remaining 48 bits may be disabled/reserved, and only 16 bits may be enabled. The CSR bank 310 having the 8 registers 314 may be connected to the bridge/component 312, to allow the bridge/component 312 to select the boundary port 504 to which the packet needs to be forwarded.

In other examples, the NoC 500 may include 16 clusters 502 with 8 boundary ports 504 each, and 4 routes/paths between each of the clusters 502. In such examples, while the number of registers remains 8, the number of fields increases to 16 (corresponding to the 16 clusters) which in turn increases the number of bits required per register to 64 bits. If each physical register has 64 bits, then the registers 314 may have all bits enabled, and no bits disabled.

However, in further examples, the NoC 500 may include 96 clusters 502, with 8 boundary ports 504 each and 1 route/path between each of the clusters 502. If the physical registers have 64 bits, a single register may not be able to support all 96 single bit fields (corresponding to the 96 clusters) for each of the boundary port 504, since supporting 96 such fields require 96 bits. Hence, in such examples, multi-registers/register group (i.e. a set of multiple physical registers) may be used for each boundary port 504. For example, a multi-register/register group having a set of 2 (64-bit) physical registers may be used for each boundary port 504. Since each multi-register/set of registers has 128 bits, all 64 bits of a first physical register, and 32 bits of a second physical register may be enabled and remaining 32 bits of the second physical register may be disabled. The CSR bank 310 for the components 312 in such NoC 500 may have 8 such multi-registers (i.e. 16 physical registers) corresponding to the number of boundary ports 504.

Further, based on processing the configurations of the components (such as the number of clusters, whether the bridge/component 312 uses a particular boundary port 504 of the bridge, and so on), the reset values for the registers 314 may be determined. For example, the 96 clusters 502 may be either unique, or 96 instantiations of one cluster design. In case the clusters 502 are instantiations of one design, each cluster 502 may have a different route to its boundary ports 504, thereby requiring reset values to be determined and set for each component 312 in each instantiation of the cluster design. The reset values may be set when making connections between the register 314 and the corresponding bridge/component 312, and also when formulating the IP-XACT specification for the user. In some implementations, the reset values may be parameterized and implemented using reset straps in the CSR banks 310. Similarly, other configurations may be used as parameters for determining, among other aspects, the size and number of fields and registers 314 to be incorporated into the CSR banks 310.

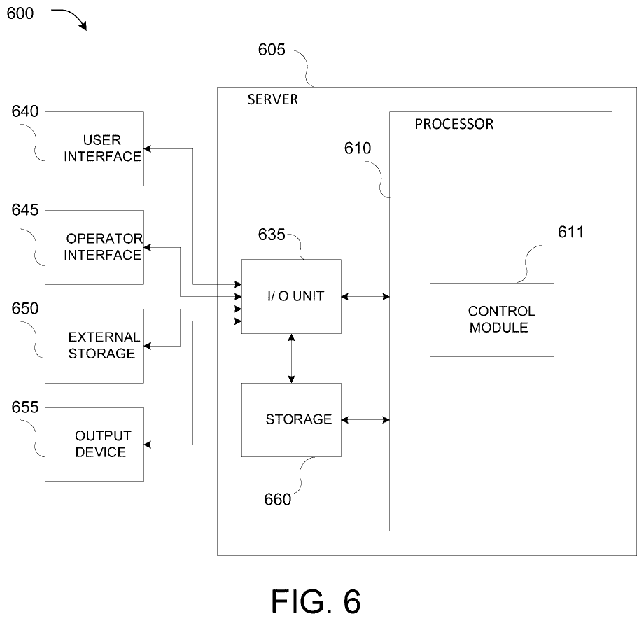

In some embodiments, the method 400 of the present disclosure may be implemented in a computer system/apparatus. FIG. 6 illustrates an example computer system 600 on which example embodiments may be implemented. The computer system 600 includes a server 605 which may include an Input/Output (I/O) unit 635, storage 660, and a processor 610 operable to execute one or more units as known to one of skill in the art. The term “computer-readable medium” as used herein refers to any medium that participates in providing instructions to processor 610 for execution, which may come in the form of computer-readable storage mediums, such as, but not limited to, optical disks, magnetic disks, read-only memories, random access memories, solid state devices, and drives, or any other types of tangible media suitable for storing electronic information, or computer-readable signal mediums, which can include transitory media such as carrier waves. The I/O unit 635 processes input from user interfaces 640 and operator interfaces 645 which may utilize input devices such as a keyboard, mouse, touch device, or verbal command.

The server 605 may also be connected to an external storage 650, which can contain removable storage such as a portable hard drive, optical media (CD or DVD), disk media, or any other medium from which a computer can read executable code. The server may also be connected to an output device 655, such as a display to output data and other information to a user, as well as request additional information from a user. The connections from the server 605 to the user interface 640, the operator interface 645, the external storage 650, and the output device 655 may be via wireless protocols, such as the 802.11 standards, Bluetooth® or cellular protocols, or via physical transmission media, such as cables or fiber optics. The output device 655 may therefore further act as an input device for interacting with a user.

The processor 610 may include a control module 611 that is configured to implement the method 400, among other functions.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A method, comprising:
generating at least one repeatable field group from a plurality of defined fields, each of the plurality of defined fields defining portions of a register and Network on Chip (NoC) connectivity;
generating at least one repeatable multi-register from the at least one repeatable field group; and
generating at least one control/status register (CSR) group from the at least one repeatable multi-register, the at least one CSR group generated to be incorporated into a CSR bank.

2. The method of claim 1, wherein the CSR bank is configured to be shared with multiple components.

3. The method of claim 1, wherein the plurality of defined fields and size of the fields is defined from processing component configurations from a specification.

4. The method of claim 3, wherein each generating step is performed from processing component configurations from the specification.

5. The method of claim 1, wherein each of the plurality of defined fields is defined by at least one of: a number of bits, bits usage by component, an access type, an offset, or a reset value for each instance.

6. The method of claim 5, wherein the field definitions are combinable with other registers to produce/obtain other values.

7. A computer-readable storage medium storing instructions for executing a process, comprising:
generating at least one repeatable field group from a plurality of defined fields, each of the plurality of defined fields defining portions of a register and Network on Chip (NoC) connectivity;
generating at least one repeatable multi-register from the at least one repeatable field group; and
generating at least one control/status register (CSR) group from the at least one repeatable multi-register, the at least one CSR group generated to be incorporated into a CSR bank.

8. The computer-readable storage medium of claim 7, wherein the CSR bank is configured to be shared with multiple components.

9. The computer-readable storage medium of claim 7, wherein the plurality of defined fields and size of the fields is defined from processing component configurations from a specification.

10. The computer-readable storage medium of claim 9, wherein each generating step is performed from processing component configurations from the specification.

11. The computer-readable storage medium of claim 7, wherein each of the plurality of defined fields is defined by at least one of: a number of bits, bits usage by component, an access type, an offset, or a reset value for each instance.

12. The computer-readable storage medium of claim 11, wherein the field definitions are combinable with other registers to produce/obtain other values.

13. A system, comprising a control module configured to:
generate at least one repeatable field group from a plurality of defined fields, each of the plurality of defined fields defining portions of a register and Network on Chip (NoC) connectivity;
generate at least one repeatable multi-register from the at least one repeatable field group; and
generate at least one control/status register (CSR) group from the at least one repeatable multi-register, the at least one CSR group generated to be incorporated into a CSR bank.
